(19) United States
(12) Patent Application Publication
(10) Pub. No.: US 2005/0204344 A1
(43) Pub. Date: Sep. 15, 2005

(54) Program analysis device, analysis method and program of same

(76) Inventor: Hideaki Shinomi, Yokohama-shi (JP)

Correspondence Address: IBM CORPORATION;INTELLECTUAL PROPERTY LAW, 11400 BURNET ROAD, AUSTIN, TX, 78758, US

(21) Appl. No.: 11/065,568

(22) Filed: Feb. 24, 2005

(30) Foreign Application Priority Data
Mar. 12, 2004 (JP) 2004-71445

(51) Int. Cl. G06F 9/44

(52) U.S. Cl. 717/124; 717/141

(57) ABSTRACT

A method for analyzing an original program to check an affected part by weaving an aspect and presenting the analysis result. An analysis device has an analysis processing portion for inputting a program based on aspect oriented programming, and acquiring data dependence information and control dependence information in the input program. A influence tracking portion tracks the data dependence and the control dependence acquired by the analysis processing portion starting from a position of weaving an aspect in the program, and searching a propagation path of the influence due the aspect weaving. A display control detects and displays a part undergoing the aspect weaving influence, based on the result of parsing by the analysis processing portion and information about the propagating path obtained by the influence tracking portion.

### FIELD OF THE INVENTION

The present invention relates to aspect oriented programming (AOP), and in particular, to a system and method for analyzing a program and outputting an analysis result thereof.

### BACKGROUND ART

In recent years, aspect oriented programming is attracting a great deal of attention. The aspect oriented programming is a programming method for implementing a concept of separation of concerns (refer to Patent Document 1 for instance.)

For instance, object orientation introduces modularity having a unit called a class in which data and procedure are grouped, and realizes design implementation called an object which is different from a conventional procedural language. However, there exists a matter of concern crosscutting the units called the classes, which cannot be design-implemented as a module in the object orientation. The matters of concern crosscutting the classes are called crosscutting concerns, and logging and security are often cited as examples.

The crosscutting concerns will be described by citing the logging as an example.

It is assumed that there is a description of adding a function of outputting the logging to a file in a specification of software. This is the matter of concern about the logging. In the case of Java® (trademark of Sun Microsystems, U.S.A.) for instance, it is necessary, for the sake of adding this function, to add an output sentence for outputting a log before or after every method calling desired to output the log. To be more specific, the matter of concern for outputting the log is distributed in the entire program at the time of implementation. It means that the matter of concern for outputting the log is in a different dimension from a class design led by an object orientation analysis, and is crosscutting as to the classes and methods. Consequently, the aspect oriented programming allows the function of outputting the log (crosscutting concern) to be written at one part as a bunch of modules (aspects) instead of describing it in a dispersive manner in the program.

Thus, the aspect oriented programming describes the module equivalent to the crosscutting concern as the aspect apart from the class and performs weaving to each class so as to generate a program.

As another example, consideration is given to a program of a simple graphics editor for manipulating points and lines (refer to Nonpatent Document 1 and 2 for instance).

FIG. 27 is a UML (Unified Modeling Language) diagram of this graphics editor described in Nonpatent Document 1 and 2.

In a Point class and a Line class in FIG. 27, a method of getX, getY, getP1 and getP2 just for returning a position thereof requires no process after a call therefor. However, graphics change their positions as to setX, setY, moveBy, setP1, setP2 and moveBy so that it is necessary to update the screen as an operation of the editor.

In this case, normal Java® programs so far required a sentence for updating the screen to be written in all the parts related to setX, setY, moveBy, setP1, setP2 and moveBy. The aspect oriented programming regards “updating the screen” in this case as the crosscutting concern and allows it to be written in one part as the module called the aspect.

FIG. 28 is a diagram showing an example of a description of the aspect for implementing a screen update function of the graphics editor in FIG. 27 described in Nonpatent Document 1 and 2. In FIG. 28, a DisplayUpdating aspect for implementing the screen update function is described by using AspectJ which is a multipurpose aspect oriented extension of Java®.

The aspect oriented programming describes a description of the position for weaving as pointcut. Here, the method as a subject for weaving is described as pointcut and it is named move.

To describe a code executed at the position specified by pointcut, the aspect oriented programming uses an advice declaration. This example uses after advice on compiling the program, and generates the program wherein the weaving is performed to insert a sentence of a screen update (Display. Update) after method calling equivalent to pointcut defined as move earlier so as to be finally compiled in a Java® bite code.

Thus, it is possible, in the aspect oriented programming, to describe the crosscutting concern such as the screen update which needed to be described in a dispersive manner in the conventional Java® in one part as the aspect so as to improve maintainability of the program.

The above described application of the aspect oriented programming to the object oriented design and language by citing AspectJ as an example. However, the aspect oriented programming itself is also applicable to a structured design/procedural language, and is broadly applicable apart from the object oriented programming.

[Patent Document 1] Published Unexamined Patent Application No. 2003-233499

[Nonpatent Document 1] G. Kiczales, “Aspect oriented Programming with AspectJ,” Object orientation 2002 Symposium Data Vol. 2, 2002

[Nonpatent Document 2] Toshiyuki Omori, et al., “Unknown Defects of Java® (II),” Nikkei Byte October 2002, Nikkei Business Publications, Inc., 2002

### PROBLEMS TO BE SOLVED BY THE INVENTION

As mentioned above, weaving an aspect to a class in aspect oriented programming is a very useful function. However, the following problems arise because a system automatically weaves the aspect on compilation.

1. Necessity of Bug Tracking Support

In the case where a bug which did not exist in a program before weaving the aspect is in the program after the weaving, it is necessary to inversely track a flow of execution from a place where a value of the program is found different from an assumed value so as to clarify which aspect introduced the bug on the weaving.

A programmer maintains the program before the weaving and the aspect described separately from it. Therefore, even if it is discovered that the value is different from the expected value at a certain position in the program before the weaving, the programmer must track it while being conscious of the program after the weaving in order to track execution order from there and get to the aspect including the bug.

2. Verification of Influence on Execution Order of Sentences and Output Results from the Sentences in an Original Program

Depending on the aspect, there are the cases where the weaving does not influence the execution order and output results as to the sentences in the original program but only and purely adds the function. For instance, a log output is such a case.

However, even though it is assumed to perform the weaving which “does not influence the execution of the sentences in the original program”, there is a possibility that the programmer writes the aspect which “influences the execution of the sentences in the original program” due to a description error (bug).” Here, “to influence the execution of the sentences in the original program” means that “the execution order of the sentences existing in the original program and calculation results of each sentence are changed by the weaving”, and “not to influence the execution of the sentences in the original program” means that “the execution order of the sentences in the original program and calculation results of the sentences are not changed at all by the weaving, and only the function is purely added by the weaving of the aspect” (same in the following description in this specification).

3. Efficiency of a Test After the Weaving

An extent to which the influence of the weaving of the aspect is exerted is not exactly clarified. Therefore, in the case of testing the program, it is not possible to specify which test case should be retested after weaving the aspect even when the original program has already been tested and there are sufficient test cases. For that reason, it is necessary to retest all the test cases and redundantly test the test cases not requiring retesting. Thus, efficiency of a test process is deteriorated.

As for a tool for visualizing an aspect weaving position in the aspect oriented programming, there is Aspect Visualizer in AJDT (AspectJ Development Tools) which is an AspectJ development environment on an eclipse basis.

FIG. 29 is a diagram showing an example of an output screen of Aspect Visualizer.

However, the function of Aspect Visualizer is just to indicate the position in a Java® file at which the aspect was weaved. In the case where a change is made in the aspect as to an assignment to a data field of an object or a target object or an assignment to a return value in a parameter of method calling at an event (may be considered a kind of side effect), the influence of the weaving of the aspect on the original program will propagate via the field, return value and so on. It is not possible, however, to analyze this influence with Aspect Visualizer.

Thus, it is not possible to solve the above-mentioned problem with Aspect Visualizer.

Therefore, an object of the present invention is to provide a method of analyzing which part of the original program is influenced by the weaving of the aspect.

Another object of the present invention in addition to the above is to implement a system for presenting an analysis result and thereby supporting tracking of the aspect which is a cause of the bug having arisen after weaving the aspect.

A further object of the present invention in addition to the above is to implement the system for presenting the analysis result and thereby verifying whether or not the aspect “does not influence the execution of the sentences in the original program” without executing the program after weaving the aspect.

A still further object of the present invention in addition to the above is to specify the test case to be retested after weaving the aspect based on the analysis result and increase the efficiency of the test process.

### SUMMARY OF THE INVENTION

The present invention for attaining the objects is implemented as a program analysis device constituted as follows for analyzing a computer program. This device comprises an analysis processing portion for inputting a program based on an aspect oriented programming, analyzing the inputted program, and acquiring information on a data dependence(s) and a control dependence(s) in the program; an influence tracking portion for tracking the data dependence(s) and the control dependence(s) acquired by the analysis processing portion starting from a position of weaving an aspect in the program and searching a propagating path of influence due to weaving of the aspect; and a display control portion for detecting and displaying a part influenced by the weaving of the aspect in the program, based on the result of a parsing(syntax analysis) by the analysis processing portion and the information on the propagating path of the influence due to the weaving of the aspect obtained by the influence tracking portion.

Here, to describe it further in detail, the analysis processing portion performs the parsing of the program and generates a control flow graph of the program, analyzes a parent-child (caller-callee)relation of method calling in the program including a relation with advice in the aspect, and generates a program dependence graph of each method based on the control flow graph and an analysis result of the parent-child relation of the method calling. And the influence tracking portion tracks an arc representing the data dependence(s) and an arc representing the control dependence(s) in the program dependence graph from each base point existing at each weaving position of each aspect included in the program, and adds to nodes and arcs which it has passed the information indicating that they are the propagating paths. The display control portion changes a display form between a part influenced by the weaving of the aspect and other parts in the program so as to have it displayed on the display based on the information added to the nodes and arcs of the program dependence graph.

It is further desirable that the display control portion have a first window for displaying the list of modules comprising the program and a second window for displaying the source code of the module specified by the first window displayed on the display. And it changes the display form between the module influenced by the weaving of the aspect in the program and other modules on the first window and changes the display form between the part influenced by the weaving of the aspect in the module and other parts on the second window so as to be displayed on the display. And the display control portion performs a display indicating the data dependence(s) and control dependence(s) corresponding to the propagating path of the influence of the weaving of the aspect in the program.

A user (programmer) can visually recognize which portion of the program will be influenced by the weaving of an arbitrary aspect including how the influence propagates from the weaving position of the aspect by referring to the output screen thus display-controlled.

Another present invention for attaining the objects is implemented as the following program analysis method for analyzing a computer program with a computer. This program analysis method includes a first step of inputting a program to be processed based on an aspect oriented programming, performing a parsing of the inputted program to be processed; generating a program dependence graph of the program to be processed, and storing a result of the parsing and the program dependence graph in a storage device, a second step of tracking the data dependence(s) and the control dependence(s) starting from a position of weaving of an aspect in the program to be processed based on the program dependence graph and searching a propagating path of influence of the weaving of the aspect so as to store the result of the searching in the storage device, and a third step of detecting and display-outputting the part influenced by the weaving of the aspect in the program to be processed based on the result of the parsing obtained in the first step and the result of searching the propagating path of the influence of the weaving of the aspect obtained in the second step.

Furthermore, the present invention is also implemented as the program for executing processes corresponding to the steps of the above-mentioned program analysis method by controlling the computer or as the program for causing the computer to execute the functions of the program analysis device. This program can be provided by storing it in the storage device such as a magnetic disk, an optical disk or a semiconductor memory to be delivered or distributed via a network.

### ADVANTAGES OF THE INVENTION

According to the present invention thus constituted, it is possible, in the aspect oriented. programming, to analyze which part of the original program is influenced by the weaving of the aspect and display-output the result thereof.

It is possible for the user (programmer) to easily track the aspect which is the cause of the bug having arisen after weaving the aspect. It is also possible to verify whether or not the aspect “does not influence the execution of the sentences in the original program” without executing the program after weaving the aspect. Furthermore, it is possible to specify the test case to be retested after weaving the aspect based on the analysis result so as to increase the efficiency of the test process.

### BRIEF DESCRIPTION OF THE DRAWINGS

FIG. 1 is a diagram schematically showing an example of a hardware configuration of a computer suitable for performing a program analysis and outputting an analysis result according to this embodiment;

FIG. 2 is a diagram showing a functional configuration of a program analysis system according to this embodiment;

FIG. 3 is a diagram showing examples of a data dependence(s) and a control dependence(s) in a program source code;

FIG. 4 is a diagram showing the data dependence(s) and control dependence(s) in FIG. 3 on a control flow graph;

FIG. 5 is a diagram for explaining the configuration of a program dependence graph generated by an analysis processing portion according to this embodiment;

FIG. 6 is a diagram showing a configuration example of the output screen display-outputted by the display control portion according to this embodiment;

FIG. 7 is a diagram showing another display example of the weaving influence display window of the display screen shown in FIG. 6;

FIG. 8 is a diagram for explaining display contents of the detail display window on the display screen shown in FIG. 6;

FIG. 9 is a diagram for explaining other display contents of the detail display window on the display screen shown in FIG. 6;

FIG. 10 is a diagram showing a source code of a SampleMain class which is to be processed according to this embodiment;

FIG. 11 is a diagram showing the source code of an Account class which is to be processed according to this embodiment;

FIG. 12 is a diagram showing the source code of a Balanceformat class which is to be processed according to this embodiment;

FIG. 13 is a diagram showing the source code of a ForeignCurrency aspect which is to be processed according to this embodiment;

FIG. 14 is a diagram showing the source code of a Logging aspect which is to be processed according to this embodiment;

FIG. 15 is a flowchart for explaining operation of this embodiment;

FIG. 16 is a diagram showing an analysis example of a parent-child relation of method callings according to this embodiment;

FIG. 17 is a diagram showing a program dependence graph of an Account.depositMoney method according to this embodiment;

FIG. 18 is a diagram showing the program dependence graph of a ForeignCurrencyAspect$1 advice according to this embodiment;

FIG. 19 is a diagram showing the program dependence graph of a SampleMain.main method according to this embodiment;

FIG. 20 is a diagram showing arcs and nodes of the dependence(s)s tracked as influence tracking from two base points on the program dependence graph shown in FIG. 18 in heavy line;

FIG. 21 is a diagram showing the nodes and arcs tracked as the influence tracking inside the Account.depositMoney method on the program dependence graph shown in FIG. 17 in heavy line;

FIG. 22 is a diagram showing the nodes and arcs tracked for the influence of the weaving of the advice on the program dependence graph shown in FIG. 19 in heavy line;

FIG. 23 is a diagram showing a data structure of the marked program dependence graph according to this embodiment;

FIG. 24 is a diagram showing execution results of the SampleMain class without the weaving of the aspect;

FIG. 25 is a diagram showing the execution results of the SampleMain class after weaving the ForeignCurrency aspect;

FIG. 26 is a diagram showing the execution results of the SampleMain class in the case of weaving the ForeignCurrency aspect and the Logging aspect;

FIG. 27 is a UML diagram of a graphics editor created by aspect oriented programming;

FIG. 28 is a diagram showing an example of description of the aspect for implementing a screen update function of the graphics editor in FIG. 27; and

FIG. 29 is a diagram showing an example of the output screen of Aspect Visualizer.

### PREFERRED EMBODIMENT

Hereafter, preferred embodiments for implementing the present invention (hereafter, the embodiments) will be described in detail by referring to the attached drawings.

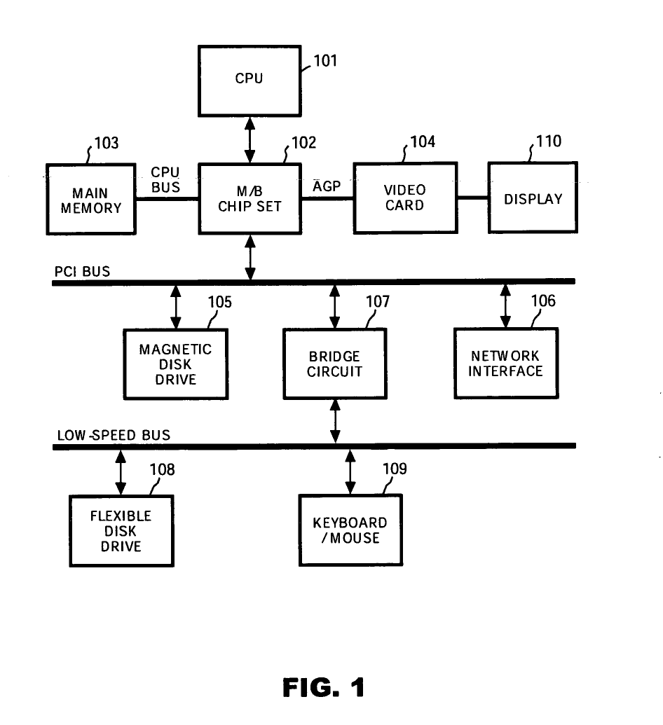

FIG. 1 is a diagram schematically showing an example of a hardware configuration of a computer suitable for performing a program analysis and outputting an analysis result according to this embodiment.

The computer shown in FIG. 1 comprises a CPU (Central Processing Unit) 101 which is computing means, a main memory 103 connected to the CPU 101 via an M/B (Mother Board) chip set 102 and a CPU bus, a video card 104 and a display 110 also connected to the CPU 101 via the M/B chip set 102 and an AGP (Accelerated Graphics Port), a magnetic disk drive (HDD) 105 and a network interface 106 connected to the M/B chip set 102 via a PCI (Peripheral Component Interconnect) bus, and a flexible disk drive 108 and a keyboard/mouse 109 connected from the PCI bus to the M/B chip set 102 via a bridge circuit 107 and a low-speed bus such as an ISA (Industry Standard Architecture) bus.

FIG. 1 only illustrates the hardware configuration of the computer for implementing this embodiment, and other various configurations may be adopted if this embodiment is applicable.

For instance, it is possible to mount only a video memory instead of providing the video card 104 so as to process image data with the CPU 101. It is also possible to provide a CD-R (Compact Disc Recordable) drive or a DVD-RAM (Digital Versatile Disc Random Access Memory) drive via an interface such as ATA (AT Attachment) or SCSI (Small Computer System Interface) as an external storage.

FIG. 2 is a diagram showing a functional configuration of a program analysis system according to this embodiment.

Referring to FIG. 2, the program analysis system according to this embodiment comprises a program storage portion 10 storing the program described in an aspect oriented programming language, an analysis processing portion 20 for reading the program to be processed from the program storage portion 10 and performing a parsing and a dependence(s) analysis, an influence tracking portion 30 for tracking influence in the case of weaving an aspect to a class in a program based on an analysis result of the analysis processing portion 20, and a display control portion 40 for creating and display-outputting an output screen for presenting a processing result of the program to a user (programmer) based on the processing results of the analysis processing portion 20 and influence tracking portion 30.

The program storage portion 10 is implemented by the main memory 103 or the magnetic disk drive 105 shown in FIG. 1 for instance, and stores the program to be processed described in the aspect oriented programming language.

For instance, the analysis processing portion 20 is implemented by the program-controlled CPU 101 in FIG. 1, reads the program to be processed from the program storage portion 10, performs the parsing and generates a syntax tree reflecting a program structure and a symbol table for managing function identifiers and variable identifiers so as to generate a control flow graph (CFG) representing a control flow from the syntax tree. It also analyzes a method calling relation (parent-child relation). And it also analyzes a data dependence(s) and a control dependence(s) in the program for each method based on the generated control flow graph and the analysis result of the method calling relation so as to generate a program dependence graph (PDG) having information on the data dependence(s) and control dependence(s). The generated syntax tree, symbol table, control flow graph, program dependence graph and analysis results of the method calling relation are held in the main memory 103, a cache memory of the CPU 101, magnetic disk drive 105 and so on in FIG. 1 for instance, and are used in a next process.

According to this embodiment, in the case of analyzing the method calling parent-child(caller-callee) relation, a portion described in the aspect (advice) is interpreted just as the method calling so as to perform the analysis.

The parsing according to this embodiment is the same as the parsing in an ordinary compiler process. And terms of the data dependence(s) and control dependence(s) are used in the same concepts thereof as those in program slicing. The program slicing is an existing technology for extracting a code which influences a variable noted by an arbitrary sentence in the program from an original program, which is a useful technique for developing and maintaining software for debugging, testing, reusing and so on. To be more specific, the data dependence(s) is the relation between a sentence defining a certain variable and a sentence to which a value of the variable is assigned. The control dependences() is a relation dependent on a conditional part which determines whether or not a certain sentence is executed.

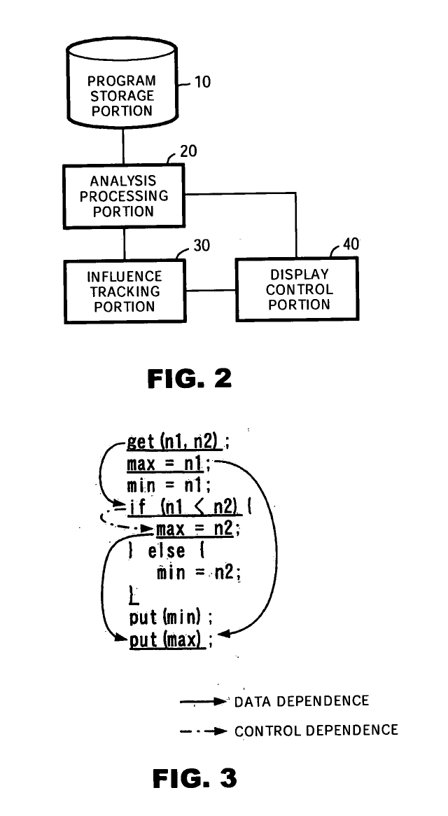

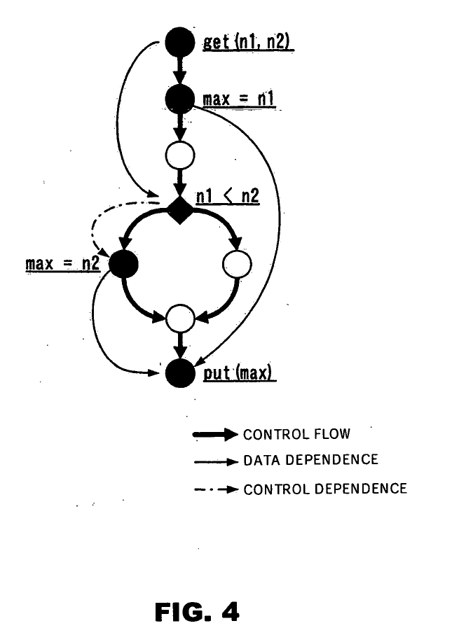

FIG. 3 is a diagram showing examples of the data dependence(s) and control dependence(s) in a program source code. FIG. 4 is a diagram showing the data dependence(s) and control dependence(s) in FIG. 3 on a control flow graph.

In FIG. 3, the values of variables n1 and n2 assigned by get (n1, n2) on a first line are referred to by if (n1, n2) on a third line, where the data dependence(s) exists. And the values of a variable max assigned by max=n1 on a second line and max=n2 on a fourth line are referred to by put (max) on a sixth line, and so the data dependence(s) exists between the second and fourth lines and the sixth line. max=n2 on the fourth line is executed subject to if (n1<n2) on the third line, and so the control dependence(s) exists between the third line and the fourth line.

FIG. 4 has the above dependence(s)s described as the dependence(s)s among the nodes on the control flow graph. In FIGS. 3 and 4, the data dependence(s) is described in full line, and the control dependence(s) is described in dashed line. In FIG. 4, arrows indicating a control flow among the nodes are described in thick full line.

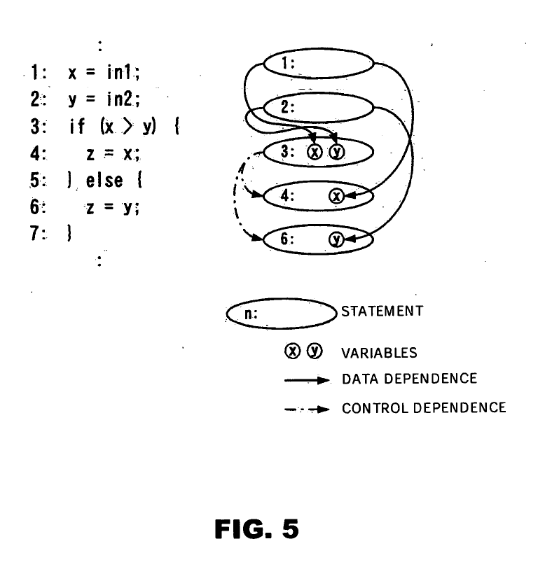

FIG. 5 is a diagram for explaining the configuration of a program dependence graph generated by the analysis processing portion 20.

In FIG. 5, the dependence(s)s among the sentences in seven lines described on the left side are represented in the program dependence graph described on the right side. To be more specific, the values of variables x and y assigned on the first and second lines are referred to the third, fourth and sixth lines respectively, and these data dependence(s)s are described in full line. And an if sentence on the third line of the program is an execution condition of the fourth and sixth lines, and these control dependence(s)s are described in dashed line.

For instance, the influence tracking portion 30 is implemented by the program-controlled CPU 101 in FIG. 1, and searches the propagating path of the influence exerted on the original program by the aspect based on the program dependence graph generated by the analysis processing portion 20.

To be more precise, the influence tracking portion 30 first discovers and lists base points of the influence exerted on the original program by the aspect. Here, the base points are as follows. To be more specific, in the case where there is an update (assignment) to a parameter of method calling or a field of a target object or a value update to a return value, the influence is exerted on the original program by the update from that weaving position. Data to be updated on this update is called the base point. It depends on the following criteria whether or not the weaving position includes the base point.

1. In the case of performing an update to values to fields of an object and a target object in a parameter in a source code of before advice or after advice (insertion before or after the method calling).

2. In the case of performing an update in accordance with the following criteria in the source code of around advice (replacement of a method itself).

[Base point criterion 1] When values to fields of an object and a target object in a parameter are updated.

[Base point criterion 2] When a value passed to a parameter to proceed( ) (an original call of a weaving subject) is updated.

[Base point criterion 3] When a return value from proceed( ) is updated and returned.

Next, the influence tracking portion 30 tracks the program dependence graph from the listed base points, and marks the paths to which the influence of the aspect will propagate due to the control dependence(s) and data dependence(s). To be more specific, regarding a predetermined aspect, it tracks an arc representing the data dependence(s) and an arc representing the control dependence(s) of the program dependence graph in turn in directions of the arrows from the base points, and adds to all the nodes which it has visited a mark (information) indicating that they are influenced by the aspect. It also adds the same mark (information) to the arcs of the data dependence(s) and control dependence(s) tracked in this process. The mark (information) added to the nodes and arcs is stored in the main memory 103 or the magnetic disk drive 105 in FIG. 1 together with the program dependence graph for instance, and is used in the process of the display control portion 40. As for a data structure of the program dependence graph to which the mark (information) indicating the influence of the aspect is added, it will be described later.

For instance, the display control portion 40 is implemented by the program-controlled CPU 101 and video card 104 in FIG. 1, and generates the output screen for presenting a processing result to a user (programmer) based on the syntax tree and symbol table generated by the analysis processing portion 20 and the program dependence graph to which the mark (information) indicating the influence of the aspect is added by the influence tracking portion 30 so as to display it on the display 110.

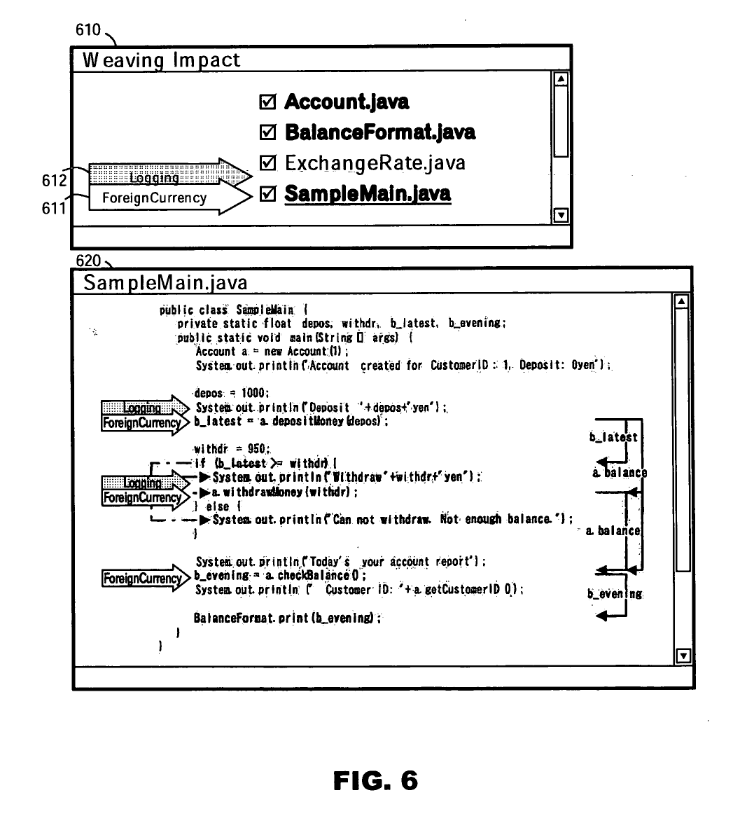

FIG. 6 is a diagram showing a configuration example of the output screen display-outputted by the display control portion 40.

The output screen shown in FIG. 6 is comprised of two windows of a weaving influence display window 610 and a detail display window 620.

The weaving influence display window 610 displays a module (class) and the aspect constituting the original program, and switches the display so as to identify the aspect being noted and the class influenced by the weaving of the aspect. As for the example shown in FIG. 6, the program to be processed is comprised of four classes of “Account.java,” “BalanceFormat.java,” “ExchangeRate.java” and “SampleMain.java” and two aspects of “ForeignCurrency” and “Logging”. The name “ForeignCurrency” of the aspect being noted is shown by an outline arrow 611, and the names of the classes Account.java, BalanceFormat.java and SampleMain.java to be influenced by the weaving of the ForeignCurrency aspect are displayed in thick print. And the name of the class SampleMain.java of which source code is displayed on the detail display window 620 is further underlined.

The switch of display shown in FIG. 6 is only an exemplification. Apart from the technique shown therein, an arbitrary method, such as changing display colors and character fonts of the characters and arrows, may be used to differentiate the class to be influenced from the class not to be influenced.

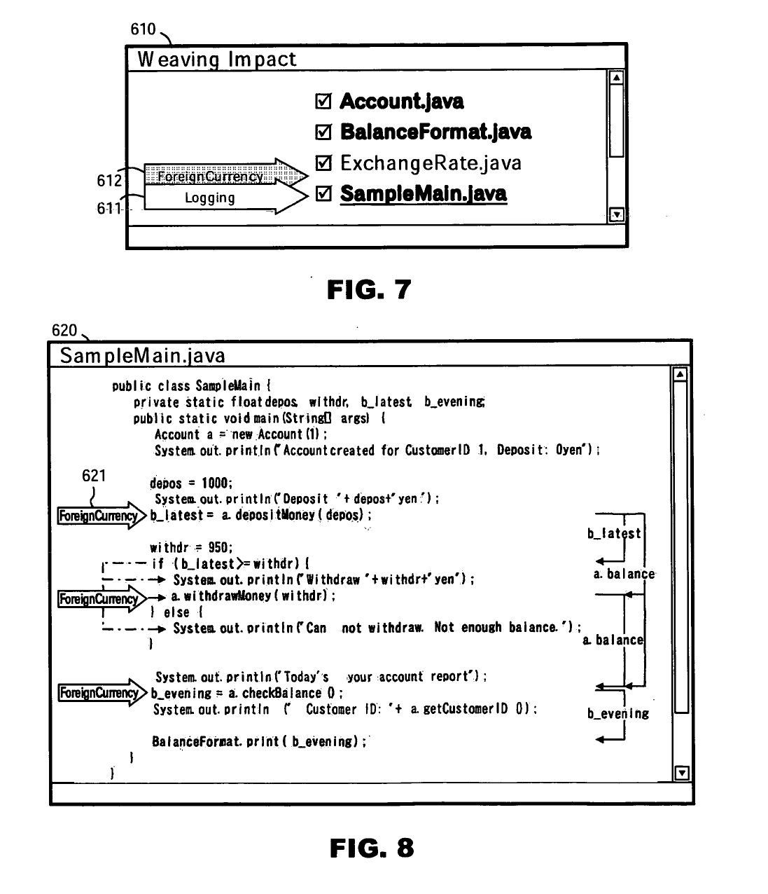

FIG. 7 is a diagram showing another display example of the weaving influence display window 610 of the display screen shown in FIG. 6.

As the example shown in FIG. 7 has switched the aspect being noted from ForeignCurrency to Logging, the outline arrow 612 describing the aspect name “Logging” is shown on the near side. There is no class to be influenced by the weaving of the Logging aspect, and so none of the four classes is described in thick full line.

FIG. 8 is a diagram for explaining display contents of the detail display window 620 on the display screen shown in FIG. 6.

The example shown in FIG. 8 shows the source code of the SampleMain class and how the influence is exerted on the SampleMain class by the weaving of the aspect. In FIG. 8, an arrow 621 on which the aspect name “ForeignCurrency” is described indicates the position at which the ForeignCurrency aspect being noted specified on the weaving influence display window 610 is woven in the SampleMain class. The arrows in full line added to the source code of the SampleMain class indicate the data dependence(s), and the arrows in dashed line indicate the control dependence(s). In the source code of the SampleMain class, the sentences to be influenced by the weaving of the ForeignCurrency aspect are described in thick full line. FIG. 8 clarifies that the weaving of the ForeignCurrency aspect into the SampleMain class influences the sentence to be directly changed as well as the sentences in the data dependence(s) or the control dependence(s) with this sentence. The arrows in full line indicating the data dependence(s) have descriptions of the variables to be referred to at destinations pointed by the arrows added thereto.

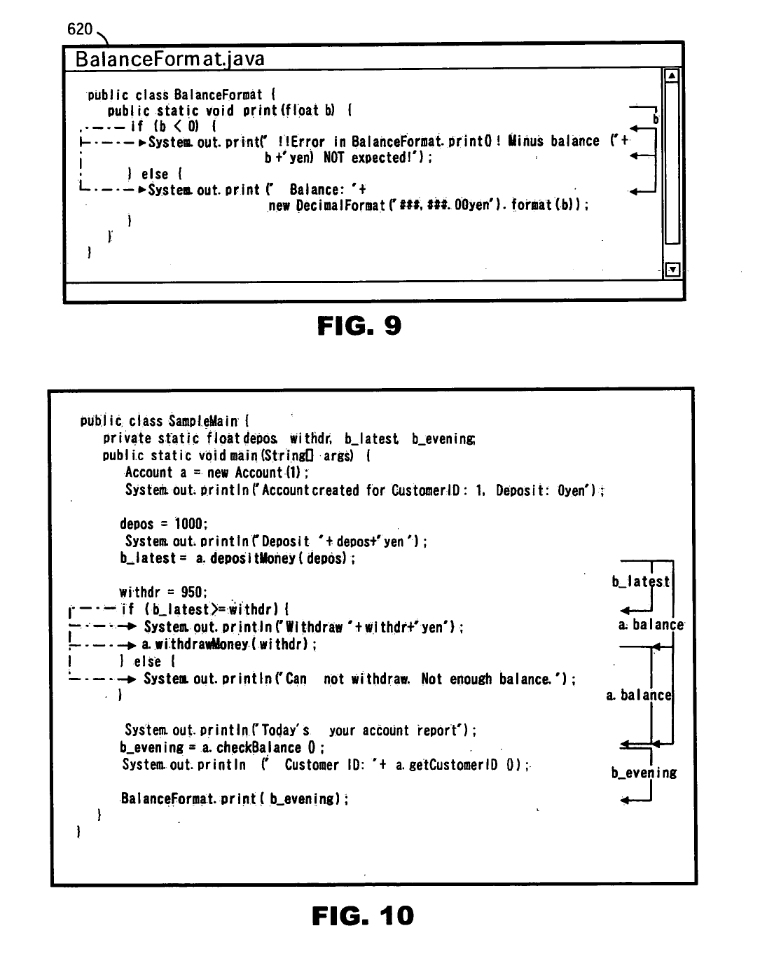

FIG. 9 is a diagram for explaining other display contents of the detail display window 620.

The example shown in FIG. 9. shows the source code of the BalanceFormat class in a state of noting the ForeignCurrency aspect as in FIG. 6. It is possible to switch the source code displayed on the detail display window 620 by specifying a desired class by means such as a mouse click on the weaving influence display window 610 for instance.

As for the example shown in FIG. 9, the BalanceFormat class does not have the ForeignCurrency aspect woven therein, and the arrow 621 on which the aspect name “ForeignCurrency” is described is not displayed. As shown in FIG. 8, however, a variable b is influenced by the weaving of the ForeignCurrency aspect into the SampleMain class, and the variable b is assigned in the sentence in the BalanceFormat class. Consequently, the BalanceFormat class is also influenced by the weaving of the ForeignCurrency aspect. And it can be understood that the influence of the weaving of the ForeignCurrency aspect is propagating to the other sentences via the data dependence(s) indicated by the arrows in full line and the control dependence(s) indicated by the arrows in dashed line.

It is possible for the user (programmer) to know which aspect woven into the program influences execution of which class by referring to the weaving influence display window 610 display-outputted by the display control portion 40 while switching the aspect to be noted. And it is possible to concretely know which sentence in each individual source code is influenced by the weaving of the aspect by having the source code of the desired class displayed on the detail display window 620 and referring to it.

Next, operation of this embodiment will be described in detail by taking a concrete program as an example.

In an operation example indicated below, the following four Java® programs (classes) and two aspects are assumed as the programs to be processed.

SampleMain.java:

A main program in Java®. It generates a bank account for a customer whose customerID is 1 and makes a deposit (1,000 yen). Compares a deposit balance checked lastly to a withdrawn amount (950 yen) so as to withdraw the deposit if the deposit balance is larger. Thereafter, it outputs an account report of the day. The deposit balance is outputted by a BalanceFormat.print method. This program itself assumes a deposit in Japanese yen. FIG. 10 shows the source code of this class.

Account.java:

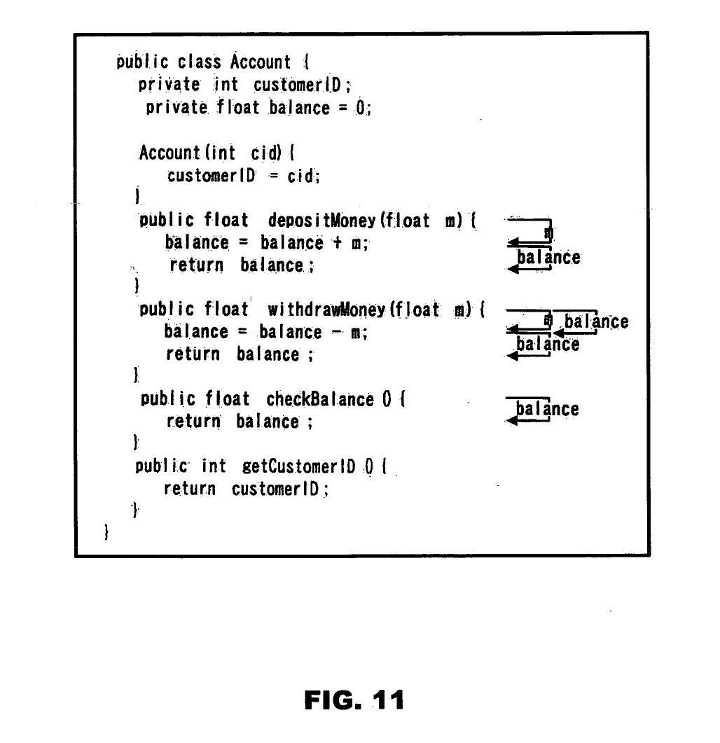

An account class in Java®. It includes a constructor for making an account object based on the customerID, a deposit method depositMoney, withdrawal method withdrawMoney and a method checkBalance for checking the deposit balance. FIG. 11 shows the source code of this class.

BalanceFormat.java:

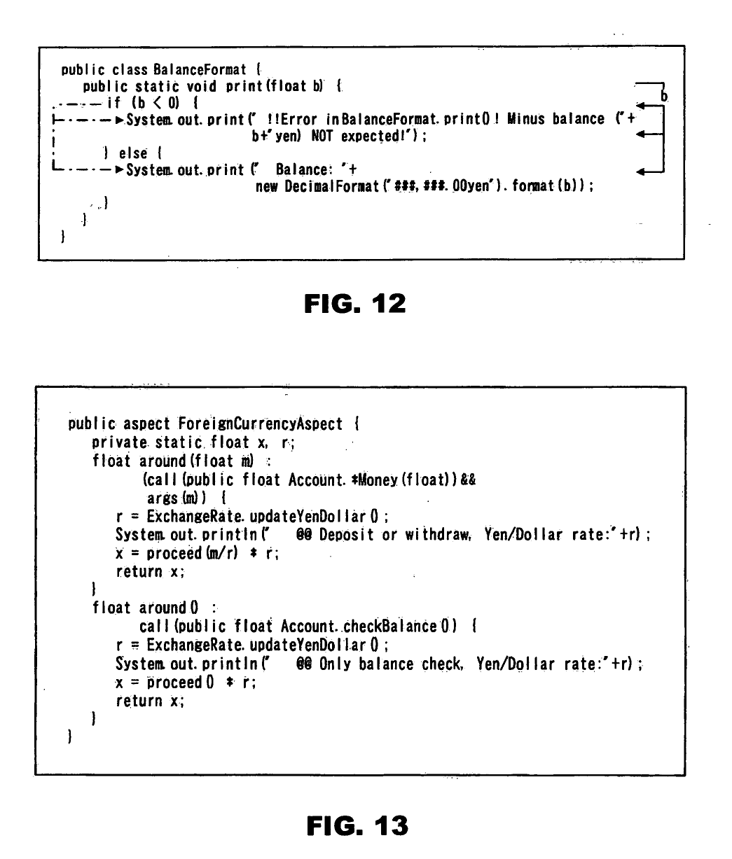

A class for a balance format in Java®. It includes a print method for displaying a formatted balance. If the balance is a minus, it is outputted as an error. FIG. 12 shows the source code of this class.

ExchangeRate.java:

A class having a method updateYenDollar for returning a conversion rate of yen/dollar at the time in Java®.

ForeignCurrencyAspect.java:

An aspect for changing a deposit to a foreign-currency deposit. Two kinds of advice are defined in this aspect.

The first replaces callings of the depositMoney method and withdrawMoney method by using around advice. proceed( ) in around advice is the calling of the original depositMoney method or withdrawMoney method. Here, a value which came to the parameter of the depositMoney method or withdrawMoney method is divided by the yen/dollar conversion rate and passed to the calling of the original method. As the depositMoney method and withdrawMoney method return the balance, the balance is returned after converting it to yen by multiplying it by the conversion rate.

The second replaces the checkBalance method in the Account class by using around advice. To be more specific, the balance to be returned by proceed which is equivalent to the original checkBalance method is returned after converting it to yen by multiplying it by the conversion rate. FIG. 13 shows the source code of this aspect.

LoggingAspect.java:

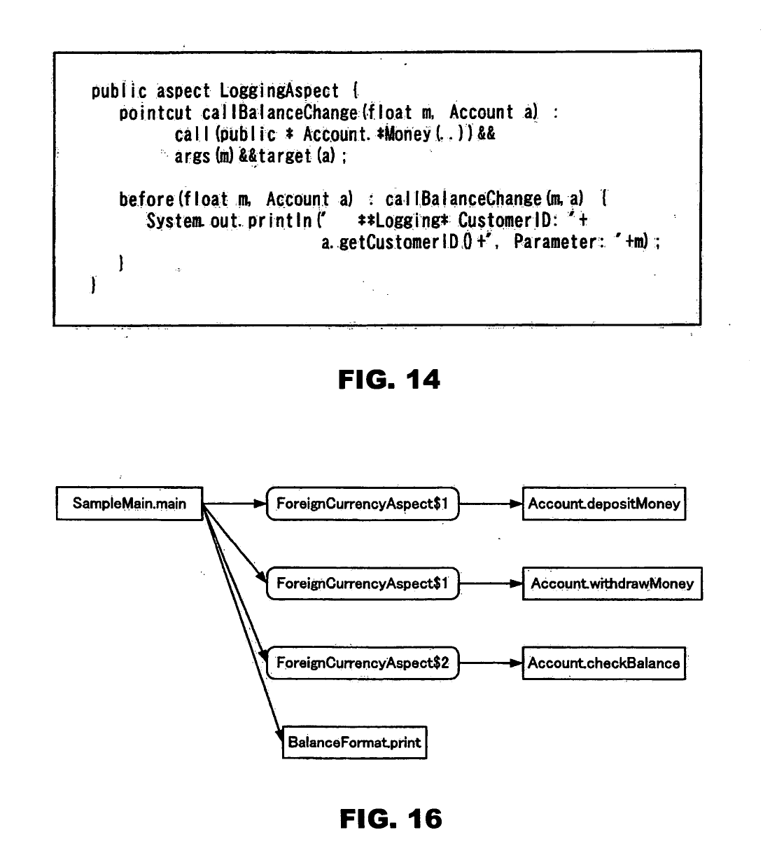

An aspect for letting in logging by AspectJ. A sentence for outputting a log is woven in immediately before calling the depositMoney method and withdrawMoney method by using before advice. FIG. 14 shows the source code of this aspect.

The source code in FIGS. 10 to 12 has the arrows indicating the data dependence(s) (full line) and the arrows indicating the control dependence(s) (dashed line) described therein, and the part influenced by the weaving of the aspect is described in thick full line. The contents of propagation of the influence of the weaving of the aspect analyzed by this embodiment will be described later. Of the four Java® programs, ExchangeRate.java is not influenced by the weaving of the aspect (no influence is propagated from another weaving part, either) so that the description of the source code is omitted.

In this operation example, the ForeignCurrency aspect is woven in the program for processing the bank account in Japanese yen (program comprised of the above-mentioned four classes of SampleMain.java, Account.java, BalanceFormat.java and ExchangeRate.java) so as to generate a program for generating a foreign currency account wherein the deposits and withdrawals are in yen but savings are put in dollars. To simplify the problem, there is no interest, and no exchange fee is charged on changing it to a dollar deposit by the weaving.

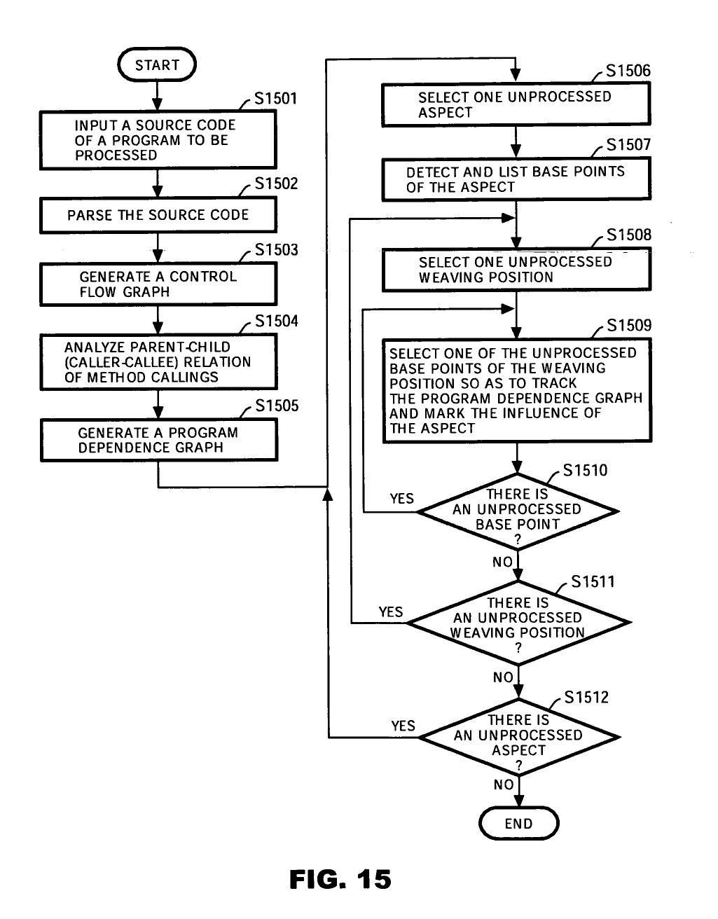

FIG. 15 is a flowchart for explaining the operation of this embodiment by citing an example of applying it to the above-mentioned program.

Referring to FIG. 15, the analysis processing portion 20 first inputs the source code of the programs to be processed (the above-mentioned four Java® programs and two aspects) from the program storage portion 10 (step 1501) and performs the parsing (step 1502). The syntax tree and symbol table are generated by the parsing.

Next, the analysis processing portion 20 generates the control flow graph showing the control flow among the sentences in each Java® program (step 1503). It also analyzes the parent-child relation of the method callings in each Java® program (step 1504). Here, as mentioned above, it analyzes the parent-child relation described in the aspect as with general method calling.

FIG. 16 is a diagram showing an analysis example of the parent-child(caller-callee) relation of the method callings.

In FIG. 16, the parent-child relations among the method callings are indicated by the arrows (the ends of the arrows are the children (called ends)). As shown in FIG. 16, the relations with other method callings are also shown as to the portions described in the aspects (ForeignCurrencyAspect$1, ForeignCurrencyAspect$2). As for the name described in round-cornered rectangle showing the aspect, “n (1 and 2 in the illustrated example)” of “<Aspect name>$n” indicates that it is an n-th advice in that aspect.

Next, the analysis processing portion 20 notes each individual method calling in turn from the child method callings of the called ends based on the relations among the method callings analyzed in the step 1503. And it generates the program dependence graph of each method calling by using the technology of the program slicing based on the syntax tree generated in the step 1502 (step 1505). At this time, interface information summarizing a data flow inside each called method is generated at the same time. The contents of the interface information will be described later.

Taking the case in FIG. 16 for instance, the program dependence graphs of Account.depositMoney and Account.withdrawMoney are generated first. And then the interface information on the data flow of each method calling is generated based on each program dependence graph. This interface information is used on generating the program dependence graphs of a first advice of ForeignCurrencyAspect (ForeignCurrencyAspect$1). Once the program dependence graph of ForeignCurrencyAspect$1 is generated, then the interface information on this advice is generated based on it.

The interface information on ForeignCurrencyAspect$2 and BalanceFormat.print is generated by using the same procedure, and this interface information is used to generate the program dependence graphs of SampleMain. main.

In FIG. 16, two ForeignCurrencyAspect$1 are placed for Account.depositMoney and Account.withdrawMoney. This is because, even if they are the same ForeignCurrencyAspect$1 on the source code, there is a possibility that the interface information on ForeignCurrencyAspect$1 itself may change depending on whether it is woven in Account.depositMoney or Account.withdrawMoney. Furthermore, it is necessary to generate the program dependence graph separately in this case. In this operation example, however, the interface information on Account.depositMoney and Account.withdrawMoney is the same as a result of the analysis described below. Therefore, the two nodes of the two ForeignCurrencyAspect$1 can be eventually united as one, and the program dependence graphs also become one.

Hereafter, the process of generating the program dependence graph will be described based on the order described above.

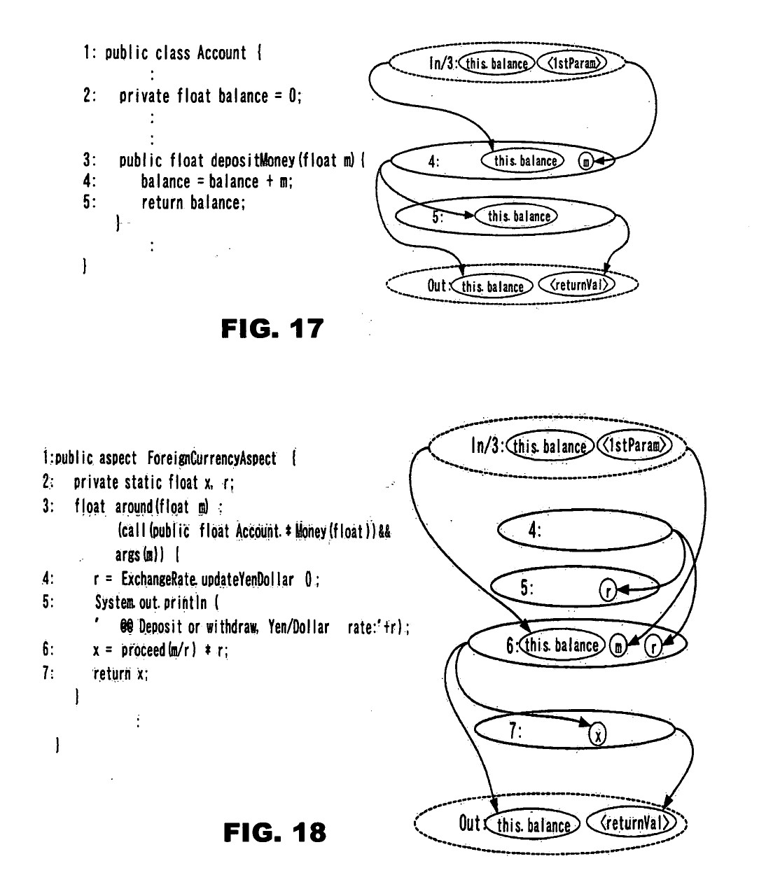

FIG. 17 is a diagram showing the program dependence graph of the Account.depositMoney method.

In FIG. 17, the node shown in dotted line is a virtual node equivalent to input-output of the data on calling the method (hereafter, the virtual node). The contents of the virtual node become the interface information summarizing the data flow of this method calling. Here, the interface information is described as follows based on the virtual node equivalent to the input-output.
USE (<1stParam>, this.balance)&DEF(<returnVal>, this.balance)

Here, USE( ) denotes the data used in that method calling part, and DEF( ) denotes the data to be assigned. <1stParam> denotes a first parameter of the method calling, and <returnVal> denotes the return value. Therefore, as for the example in FIG. 17, it can be understood that the value of the field this.balance of the class is used and assigned in addition.

Here, the interface information on the Account.depositMoney method is taken up. However, the same interface information is obtained in the case of analyzing the Account.withdrawMoney method likewise. To be more specific, the influence on a calling side is the same even if the contents of calculation are different. For that reason, the two ForeignCurrencyAspect$1 nodes in FIG. 16 become the same and the program dependence graphs thereof also become one.

In the case where, as to the method which is rather large, totally different calculations with no mutual interruption are performed by receiving the values of the parameters and fields and the results are also returned in different forms, the program dependence graph equivalent to that method may not be only one but there may be a plurality of separate program dependence graphs. In that case, the above interface description may be a plurality as follows.
USE (<1stParam>, this.x)&DEF(<returnVal>), USE (this.y)&DEF(this.y)

This is equivalent to the methods originally performing two different functions implemented as one method. When generating the program dependence graph on the method calling side in such a case, the program dependence graph is generated by rendering the node of the program dependence graph equivalent to the calling (equivalent to the sentence) as two different nodes internally.

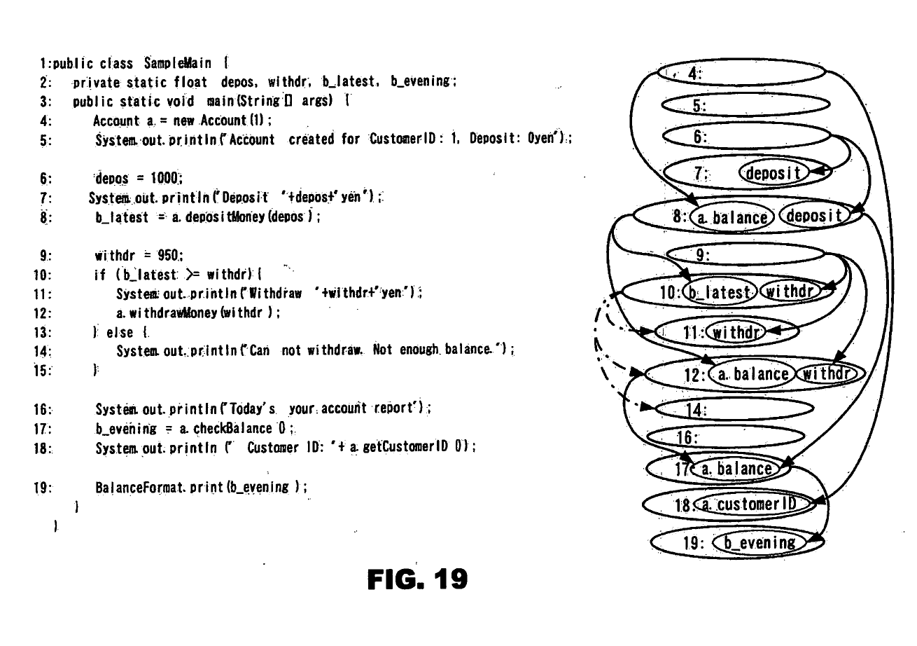

FIG. 18 is a diagram showing the program dependence graph of the ForeignCurrencyAspect$1 advice. FIG. 19 is a diagram showing the program dependence graph of the SampleMain. main method.

As described above, the program dependence graph of the ForeignCurrencyAspect$1 advice shown in FIG. 18 is generated based on the interface information on Account.depositMoney method and Account.withdrawMoney method. And proceed( ) is equivalent to Account.depositMoney, and the interface summarized as follows is used.
USE (<1stParam>, this.balance)&DEF(<returnVal>, this.balance)

As already mentioned, the interface information on the two methods is the same. Therefore, it is not necessary to generate the program dependence graph of the ForeignCurrencyAspect$1 advice for each method.

Likewise, the program dependence graph of the SampleMain.main method shown in FIG. 19 is generated by using the interface information on the ForeignCurrencyAspect$1 advice, the ForeignCurrencyAspect$2 advice and the BalanceFormat.print method.

If the program dependence graph of each method calling is generated by the analysis processing portion 20, the influence tracking portion 30 selects one aspect next (step 1506) and discovers and lists base points of the influence exerted on the original program by the aspect (step 1507). The criteria for detecting the base points are as described above.

For instance, the base points are examined as to the ForeignCurrencyAspect$1 advice in FIG. 18. As the ForeignCurrencyAspect$1 advice is around advice, each of the three base point criteria mentioned later will be considered.

First, as for the base point criterion 1, it looks as if there is an update (assignment) to this.balance in the program dependence graph. However, this is because of proceed( ) equivalent to the calling of the Account.depositMoney method or Account.withdrawMoney method, and there is no update

(substitution) to this.balance otherwise. Therefore, the base point criterion 1 is not applicable.

Next, as for the base point criterion 2, a value m of a method calling parameter is not passed as-is as the parameter of proceed( ) but is passed after a division of m/r is performed. This value is updated to become the base point. To check this, it is examined whether or not there is an update operation on the way while inversely tracking the data dependence(s) from the parameter of proceed( ).

Next, as for the base point criterion 3, it is understandable on the program dependence graph that the data dependence(s) is inversely tracked from <returnVal> of a virtual node “Out:” to arrive at a node “6:” and a multiplication of *r is thereby performed to the return value from proceed( ). Therefore, it becomes the base point.

The description sounded as if the operations such as m/r and *r should exist as requirements. In reality, however, any operation arising other than a simple assignment without changing the value (such as x=y) is regarded as the “base point.”

To summarize the above, as to the ForeignCurrencyAspect$1 advice, the parameter of the node “6:” and variable x are detected as the base points and listed.

Once the base points are listed as to the noted aspect, the influence tracking portion 30 selects one of the weaving positions of the aspect next (step 1508), and selects one of the base points of the selected weaving position so as to track and mark the influence of the aspect on the program dependence graph (step 1509). Here, tracking and marking the influence of the aspect mean to track the arcs of the data dependence(s) and control dependence(s) on the program dependence graph in turn in the directions of the arrows from the base points and add to all the arcs which it has visited and tracked the mark (information) indicating that they are influenced by the aspect. The information to be added may be ID information preset to each aspect (aspect ID) for instance.

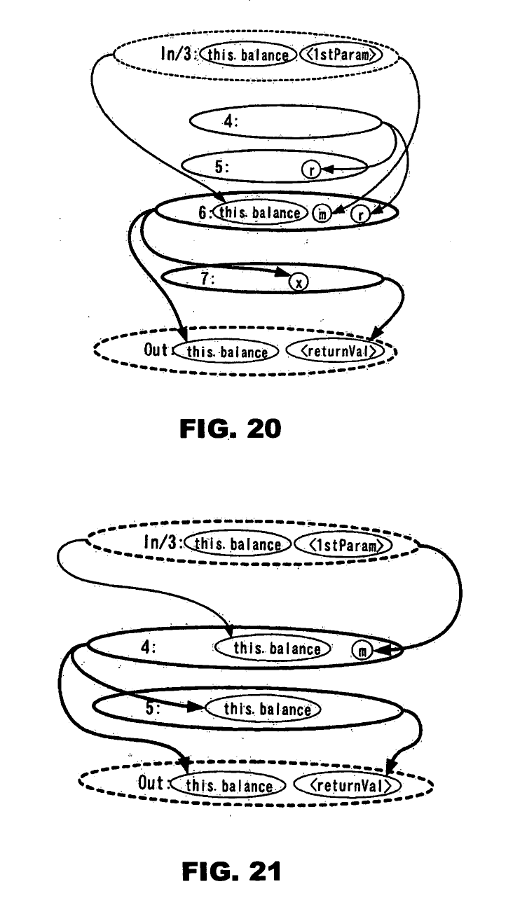

FIG. 20 is a diagram showing in heavy line the arcs and nodes of the dependence(s)s tracked as influence tracking from the two base points (parameter of the node “6:” and variable x) on the program dependence graph of the ForeignCurrencyAspect$1 advice shown in FIG. 18.

FIG. 21 is a diagram showing the nodes and arcs tracked as the influence tracking from the base point of the parameter of the node “6:” and inside the Account.depositMoney method in FIG. 17 in heavy line. If a comparison is made between the source codes of the Account class shown in FIGS. 21 and 11, the part to which the influence of the aspect propagates shown in heavy line in FIG. 21 is equivalent to the part influenced by the weaving of the aspect described in thick full line in FIG. 11. In FIG. 11, the influence of the weaving of the ForeignCurrency aspect is displayed, and it is understandable that no influence is exerted on the part related to the customer ID (here, it describes balance=balance+m instead of writing balance+=m for convenience of explanation so as to clarify the reference and update of the variable).

Furthermore, the influence tracking from the two base points in FIG. 21 is performed in all the parts in which the weaving of the ForeignCurrencyAspect$1 advice is performed. Consequently, the influence of the weaving of the ForeignCurrencyAspect$1 advice propagates to the SampleMain.main method.

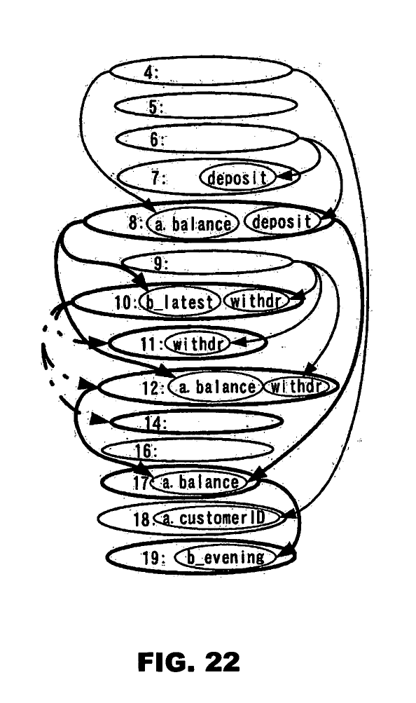

FIG. 22 is a diagram showing the nodes and arcs tracked for the influence of the weaving of the advice in FIG. 19 in heavy line. The influence of the weaving of the ForeignCurrencyAspect$1 advice on the SampleMain. main method eventually propagates as shown in FIG. 22, which is equivalent to the part influenced by the weaving of the aspect described in thick full line in FIG. 10.

The influence tracking portion 30 performs the marking process in the step 1509 to all the base points in the weaving position selected in the step 1508 (steps 1509 and 1510). If there is no more unprocessed base point, the influence tracking portion 30 returns to the step 1508 and selects one unprocessed weaving position in the same aspect anew so as to repeat the same process (step 1511). If the process is completed as to all the weaving positions in the aspect selected in the step 1506, the influence tracking portion 30 returns to the step 1506 and selects one unprocessed aspect anew so as to repeat the same process (step 1512).

If the propagating path of the influence of the weaving of the aspect are marked from all the base points as to all the weaving positions of all the aspects included in the program to be processed as described above, the influence tracking portion 30 finishes the process by storing the marked program dependence graph in a storage device such as the main memory 103 or the magnetic disk drive 105 in FIG. 1.

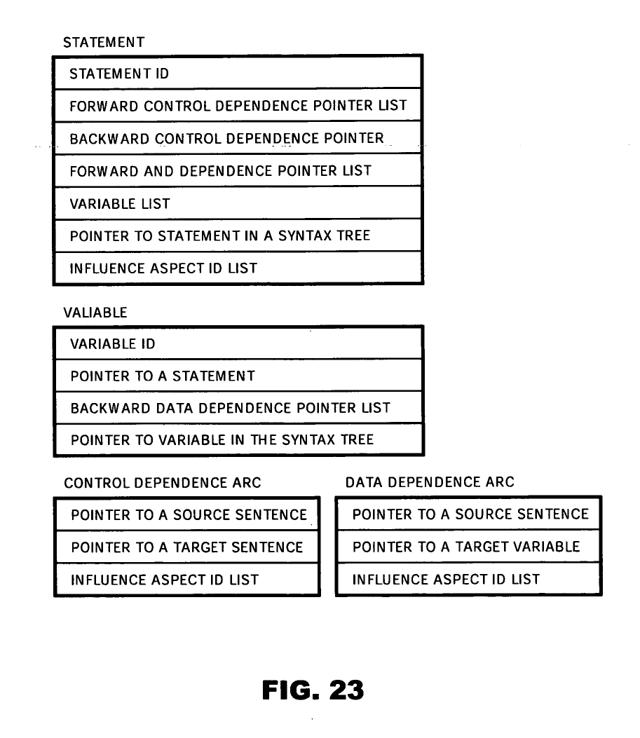

FIG. 23 is a diagram showing the data structure of the marked program dependence graph generated by the influence tracking portion 30 and stored in a predetermined storage device.

As shown in FIG. 23, the data on the program dependence graph is comprised of four kinds of data of the statements which are the data on the nodes corresponding to the sentences of the program, variables described in the nodes, control dependence arcs and data dependence arcs for representing relations among the nodes. The statement includes a statement ID, a forward control dependence pointer list which is a forward pointer to the list of the control dependence arcs, a backward control dependence pointer which is a backward pointer to the list of the control dependence arcs, a forward data dependence pointer list which is a forward pointer to the list of the data dependence arcs, a variable list which is a pointer to the list of the variables included in the statement, a pointer to the statement in the syntax tree, and an influence aspect ID list which is the list of aspect IDs of the aspects to be influenced respectively. The variable includes a variable ID, a pointer to the statement, a backward data dependence pointer list which is a backward pointer to the list of the data dependence arcs, and a pointer to the variable in the syntax tree respectively. The control dependence arc includes a pointer to a source sentence, a pointer to a target sentence and the influence aspect ID list respectively. The data dependence arc includes a pointer to a source sentence, a pointer to a target variable and the influence aspect ID list respectively.

The control dependence(s) in the program is represented by connecting the sentences by way of the “control dependence arcs,” and the data dependence(s) is represented by connecting the variables belonging to the sentences with the sentences by way of the data dependence arcs. In both the dependence(s)s, the pointers are set so that the arrows on the description of the program dependence graph shown in FIG. 5 can be tracked either forward or backward. As described above, the data structures of the statement, data dependence arc and control dependence arc include the pointers for pointing the lists capable of adding the aspect IDs of the aspects to be influenced. In the data structures of the control dependence arc and data dependence arc, a “source” means the source of the arrow of the arc and a “target” means the destination of the arrow of the arc.

Once the program dependence graph having the influence of the weaving of the aspect marked thereon is generated, the display control portion 40 generates the output screen as shown in FIG. 6 based on the data on the program dependence graph and the syntax tree and symbol table generated by the analysis processing portion 20 in the process in the step 1502 in FIG. 15 so as to display-output it.

To be more specific, as described above, the aspect IDs of the aspects which exert influence are added to the nodes and arcs of the program dependence graph having the influence of the weaving of the aspect marked thereon. Thus, in the source code displayed on the detail display window 620, the display control portion 40 performs display control based on this information over the sentence equivalent to the node to be influenced by the selected aspect such as describing it in thick full line or changing its display color as shown in FIG. 6, and further displays as the arrows the arcs of the control dependences and data dependences to which the aspect IDs are added. Consequently, the detail display window 620 has a source program displayed thereon in a form(style) shown in FIGS. 10 to 12 according to a selected class. To obtain and display the variable identifiers in the arrows of the data dependence(s)s, the pointers to target variables in the data structure of the data dependence arc shown in FIG. 23 are tracked and the variable IDs in the data structures of the variables are obtained so as to detect the variable identifiers from the symbol table based on the variable IDs.

The display control portion 40 performs the display control over all the Java® programs to be influenced (including propagation of the influence) by the weaving of the aspect on the weaving influence display window 610 displaying all the Java® programs constituting the program to be processed, such as describing them in thick full line or changing their display color as shown in FIG. 6.

Here, output results of executing the SampleMain class of the program used in the operation example will be verified.

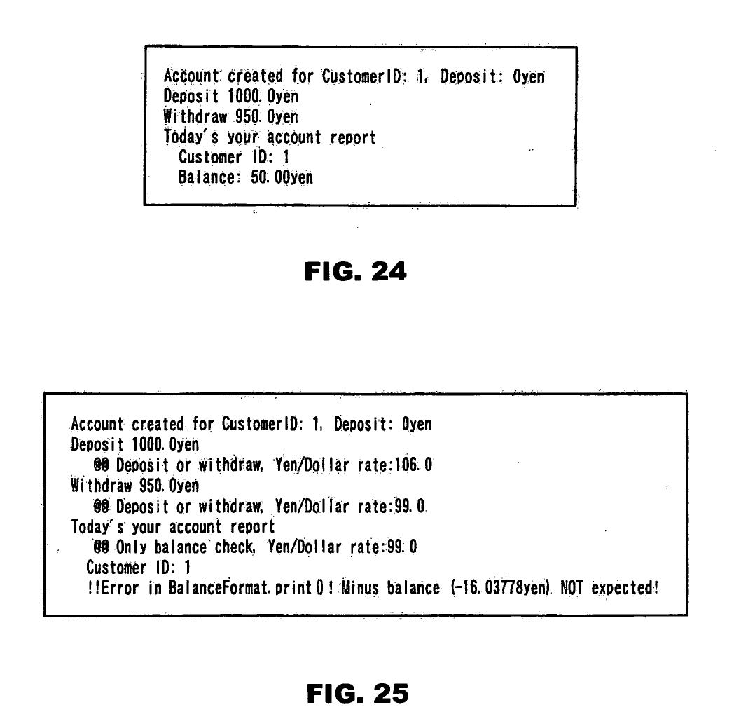

FIG. 24 is a diagram showing execution results without the weaving of the aspect.

According to the execution results shown in FIG. 24, a deposit and a withdrawal in Japanese yen were performed, and the balance in the Account object also remains in Japanese yen. The balance will not become minus as long as transactions are made in Japanese yen in terms of program logic of SampleMain.

FIG. 25 is a diagram showing the execution results after weaving the ForeignCurrency aspect.

According to the execution results shown in FIG. 25, the balance in the Account object has changed to a dollar basis due to the weaving of the ForeignCurrency aspect. The balance will not become minus in the case of FIG. 24 as described above. In the example in FIG. 25, however, an exchange loss has arisen and the balance has become minus because the conversion rate of yen/dollar changed between the deposit (credit) and withdrawal (disbursement). And the BalanceFormat.print method outputs an error because no minus value is originally assumed.

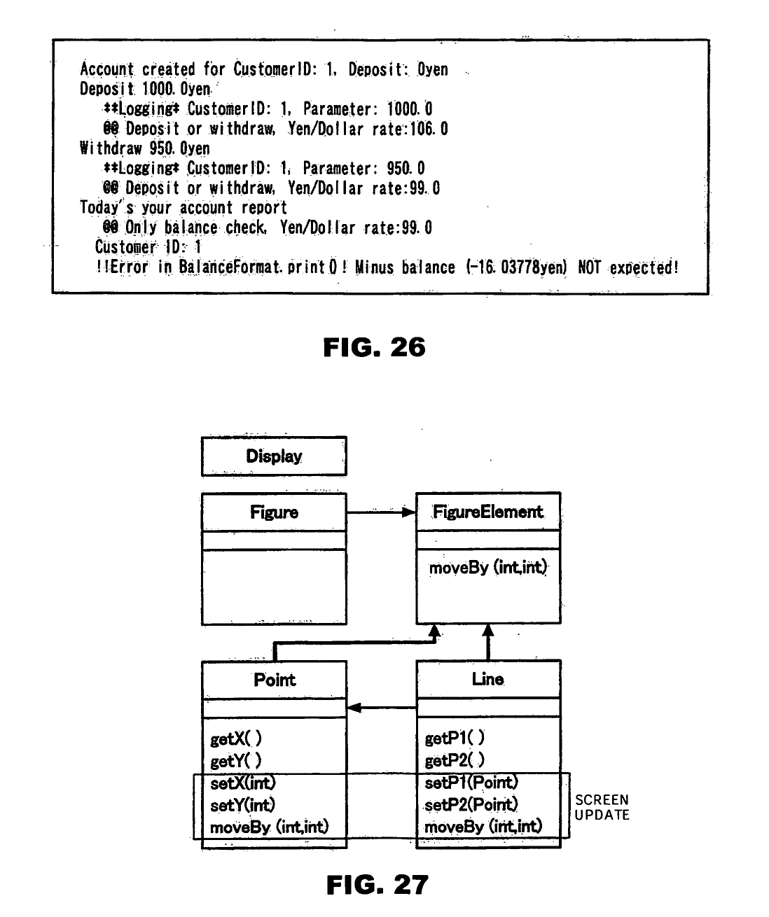

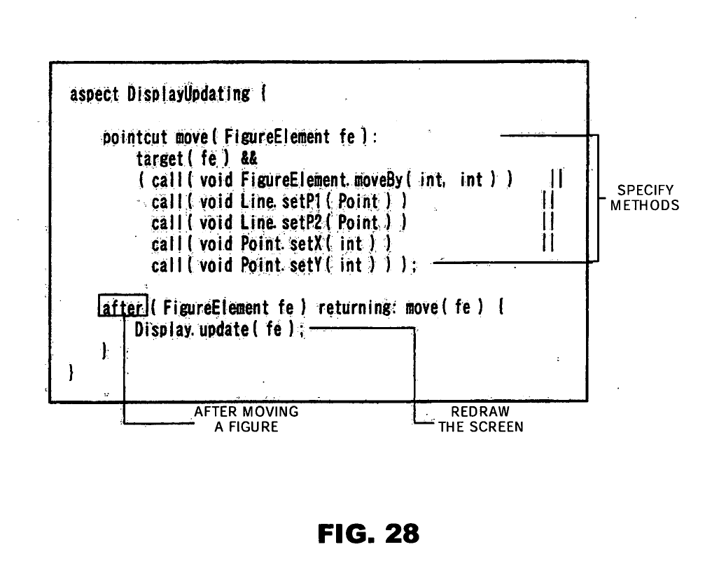

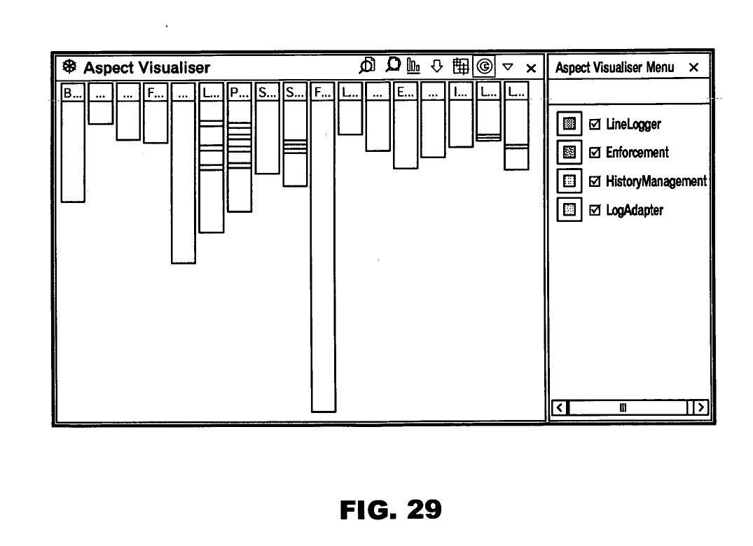

FIG. 26 is a diagram showing the execution results in the case of weaving the Logging aspect in addition to the ForeignCurrency aspect.

In addition to the output contents shown in FIG. 25, CustomerID of the target object of the depositMoney method and withdrawMoney method of the Account class and the value of the parameter of the method are outputted as logs.

The SampleMain class of the original program for processing the bank deposit in yen (refer to FIG. 10) is subject to the logic that no withdrawal is made if the deposit balance is minus as a result of comparing the balance checked lastly to the amount to be withdrawn. Therefore, the balance never becomes minus in the original program.

However, if the deposit is changed to the foreign-currency deposit in dollars by the weaving of the ForeignCurrency aspect (FIG. 13) and the program is changed to make a deposit in dollars (dollars are entered in the balance field of the Account), there will be the cases where the balance becomes minus. To be more specific, these are the cases where the balance lastly checked shrinks due to exchange rate fluctuations so that the amount once capable of withdrawal without becoming minus is withdrawn as-is, and the actual balance consequently becomes minus. Thus, a minus balance not assumed on the parameter of the BalanceFormat.print( ) method is passed, and the error is outputted in the output result in FIG. 25. Although the weaving of the ForeignCurrency aspect is not performed to the BalanceFormat class itself, an unexpected thing has occurred because the influence of the weaving on the SampleMain class propagated.

Now, the following is understandable based on this understanding by referring to FIGS. 10 to 12 which are the source codes of the Java® programs (the SampleMain class, Account class and BalanceFormat class) clearly expressing how the influence of the weaving of the aspect according to this embodiment propagates.

It is shown that the BalanceFormat class itself (the BalanceFormat.print method, to be more precise) is influenced by the weaving of the aspect (FIG. 12). And it is shown that the part in which the value different from assumption has arisen is influenced by the weaving of the ForeignCurrency aspect. The influence of the weaving of the ForeignCurrency aspect is shown not only in the BalanceFormat class but in all the influenced classes, and so it is possible, by tracking the arrows backward, to track the flow which has determined the value.

As the BalanceFormat.print method is influenced, it is understandable that, of existing test cases, there are needs to execute the test case for starting the BalanceFormat.print method. To be more specific, it is not always possible, even in the case of the class to which the weaving of the aspect is not performed, to omit a method calling test included in that class.

It is possible, though a detailed description of the operation is omitted, to verify without testing that the weaving of the Logging aspect to the four classes of SampleMain.java, Account.java, BalanceFormat.java and ExchangeRate.java which are to be processed according to this embodiment do not influence execution order of the sentences in the original program and the output results from the sentences. Therefore, it is possible to omit the test for each class as to the weaving of the Logging aspect.

Furthermore, it is understandable, by referring to the sentences described in thick print and the sentences not described in thick print in FIGS. 10, 11 and 12, that a portion related to CustomerID is not described in thick print as to the SampleMain, Account and BalanceFormat classes. To be more specific, it is understandable that the portion related to CustomerID is not influenced by the weaving of the ForeignCurrency aspect.

The description of the source code in FIGS. 10 to 12 is just as displayed on the detail display window 620 shown in FIG. 6 as described above. Therefore, it is possible for the user (programmer) to determine and track the influence of the weaving of the aspect as described above before executing the program by referring to the output screen display-outputted by the display control portion 40 as the analysis result according to this embodiment.

As described above, according to this embodiment, it is possible, in aspect oriented programming, to analyze which part of the original program is influenced by the weaving of the aspect and display-output the result including how the influence propagates.

Therefore, if this embodiment is applied to the program in which a bug has arisen after the weaving of the aspect, it is possible for the user (programmer) to easily track the aspect which is the cause of the bug by referring to the display-outputted screen.

If this embodiment is applied to the program in which the aspect is woven before execution thereof, it is possible for the user (programmer), without executing the program, to verify whether or not the aspect woven in the program influences the execution of the sentences in the original program, and if so, which sentence therein it influences by referring to the display-outputted screen.

Furthermore, if this embodiment is applied to the program in which the aspect is woven before execution of the test thereof, it is possible for the user (programmer) to determine whether or not the test case executed before the weaving of the aspect needs to be retested by referring to the display-outputted screen so as to contribute to the efficiency of the test process.

1) A program analysis device for analyzing a computer program, comprising:
an analysis processing portion for inputting a program based on an aspect oriented programming, analyzing said input program, and acquiring the information of a data dependence(s) and a control dependence(s) in said program; and
an influence tracking portion for tracking said data dependence(s) and said control dependence(s) acquired by said analysis processing portion staring from a position of weaving an aspect in said program and searching a propagating path of the influence due to weaving said aspect.

2) The program analysis device according to claim 1, in which said analysis processing portion performs a parsing of said program and generates a control flow graph of the program, analyzes a caller-callee relation of method calling in the program including a relation with advice in the aspect, and generates a program dependence graph of each method based on the control flow graph and an analysis result of the caller-callee relation of the method calling.

3) The program analysis device according to claim 2, in which said influence tracking portion tracks an arc representing the data dependence(s) and an arc representing the control dependence(s) in said program dependence graph from each base point existing at each weaving position of each aspect included in said program, and adds to nodes and arcs which it has passed the information indicating that they are said propagating paths.

4) The program analysis device according to claim 3, in which, in the case where the advice in said aspect is before advice or after advice, said influence tracking portion renders as
said base points the data to be updated when values to a field of an object and a target object in a parameter are updated in a source code of the advice.

5) The program analysis device according to claim 3, in which, in the case where the advice in said aspect is around advice, said influence tracking portion renders as said base points the data to be updated when the update is performed in accordance with the following criteria in the source code of the advice.
Base point criterion-1: When values to fields of an object and a target object in a parameter are updated.
Base point criterion-2: When a value passed to a parameter to proceed( ) (an original call of a weaving subject) is updated.
Base point criterion-3: When a return value from proceed( ) is updated and returned.

6) A program analysis device for analyzing a computer program, comprising:
an analysis processing portion for inputting a program based on an aspect oriented programming, analyzing said input program, making a parsing for said program, and creating a program dependence graph of said program;
an influence tracking portion for tracking a data dependence(s) and a control dependence(s) starting from a position of weaving an aspect in said program, based on said program dependence graph created by said analysis processing portion, and searching a propagating path of the influence due to weaving said aspect; and
a display control portion for detecting and displaying a part undergoing the influence due to weaving said aspect in said program, based on the result of said parsing by said analysis
processing portion and the information of said propagating path of the influence due to weaving said aspect obtained by the influence tracking portion.

7) The program analysis device according to claim 6, in which said display control portion has a source code of said program displayed on a display and changes a display form between a part influenced by the weaving of said aspect in the program and other parts so as to have it displayed on the display.

8) The program analysis device according to claim 6, in which said display control portion has the source code of said program displayed on the display and performs a display indicating the data dependence(s) and control dependence(s) corresponding to the propagating path of the influence of the weaving of said aspect in the program.

9) The program analysis device according to claim 6, in which said display control portion has a list of modules comprising said program displayed on the display and changes the display form between the module influenced by the weaving of said aspect in the program and other modules so as to be displayed on the display.

10) The program analysis device according to claim 6, in which said display control portion has a first window for displaying the list of modules comprising said program and a second window for displaying the source code of the module specified by the first window displayed on the display, changes the display form between the module influenced by the weaving of said aspect in the program and other modules on the first window and changes the display form between the part influenced by the weaving of said aspect in the module and other parts on the second window so as to be displayed on the display.

11) The program analysis device according to claim 7 in which:
said influence tracking portion tracks the arc representing the data dependence(s) and the arc representing control dependence(s) in said program dependence graph from each base point existing at each weaving position of each aspect included in the program, and adds to nodes and arcs which it has passed the information indicating that they are said propagating paths; and
said display control portion controls said display form based on said information added to the nodes and arcs of said program dependence graph.

12) A program analysis method for analyzing a computer program with a computer, comprising:
inputting a processing object program based on an aspect oriented programming, making a parsing for said input processing object program, creating a program dependence graph for said processing object program, and storing the result of said parsing and said program dependence graph in a storage unit; and
tracking a data dependence(s) and a control dependence(s) starting from a position of weaving an aspect in said processing object program, based on said program dependence graph, searching a propagating path of the influence due to weaving said aspect and storing a search result in said storage unit.

13) The program analysis method according to claim 12, in which:
said inputting step includes:
performing the parsing of said program to be processed and generating a control flow graph of the program;
analyzing a caller-callee relation of method calling in the program to be processed including a relation with advice in the aspect; and
generating a program dependence graph of each method based on the control flow graph and an analysis result of the caller-callee relation of the method calling.

14) The program analysis method according to claim 12, further including detecting and display-outputting the part influenced by the weaving of said aspect in the program to be processed based on the result of said parsing obtained in inputting first step and the result of searching the propagating path of the influence of the weaving of said aspect.

15) The program analysis method according to claim 14, which, in said tracking step, tracks an arc representing the data dependence(s) and an arc representing control dependence(s) in said program dependence graph from each base point existing at each weaving position of each aspect included in the program to be processed, and adds to nodes and arcs which have been passed the information indicating that they are said propagating paths; and
in said detecting step, changes a display form between a part influenced by the weaving of said aspect in the program and other parts so as to be displayed on the display based on said information added to the nodes and arcs of said program dependence graph.

16) The program analysis method according to claim 14, which, in said detecting step, has the source code of said program displayed on the display and performs a display indicating the data dependence(s) and control dependence(s) corresponding to the propagating path of the influence of the weaving of said aspect in the program.

17) (canceled)

18) (canceled)

19) (canceled)

20) (canceled)
